(19) United States
(12) Patent Application Publication
(10) Pub. No.: US 2001/0026537 A1
(43) Pub. Date: Oct. 4, 2001

(54) Satellite internet backbone network system using virtual onboard switching

(76) Inventor: Michael Massey, Los Angeles, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/792,770

(22) Filed: Feb. 23, 2001

Related U.S. Application Data
(60) Provisional application No. 60/184,576, filed on Feb. 24, 2000.

(51) Int. Cl. H04Q 7/00

(52) U.S. Cl. 370/316; 370/329

(57) ABSTRACT

The present invention relates to satellite Internet backbone technology to support high-throughput with minimum latency. More particularly, the present invention relates to a system and method for an intelligent routing and switching scheme designed to interoperate with international standards for satellite uplink and downlink equipment and various terrestrial Internet Protocol (“IP”) networks. In addition, a novel network management system is disclosed which permits remote management of the entire network from either a network node or via the Internet. Such management provides for complete management of bandwidth allocation as well as permitting Internet Service Providers (“ISPs”) to enter into peering agreements.

This application claims the benefit of U.S. Provisional Application No. 60/184,576, filed Feb. 24, 2000.

### FIELD OF INVENTION

The present invention relates to satellite Internet backbone technology to support high-throughput with minimum latency. More particularly, the present invention relates to a system and method for an intelligent routing and switching scheme designed to interoperate with international standards for satellite uplink and downlink equipment and various terrestrial Internet Protocol (“IP”) networks. The invention implements a unique deployment of Digital Video Broadcast Satellite (DVB-S) technology for creation of a mesh Internet backbone having low latency.

### BACKGROUND OF THE INVENTION

The demand for broadband services is expected to grow dramatically in the next few years particularly in developing regions of the world. Thus, there will be an ever increasing demand for higher data rate links. Currently, the most common terrestrial data rate links are T1 (1.544 Mbps) and T3 (44.7736 Mbps). However, in the near future, terrestrial broadband networks are expected to utilize fiber optic links at rates exceeding 100 Mbps more frequently due to advances in electronics and switching architectures. A natural extension to these terrestrial networks, via a satellite network, would require a flexible allocation of a range of rates between 3 and 100 Mbps, and an aggregate network capacity of 1 Gbps or more, within a single satellite footprint covering a large country, geographic region or continent. Thus, a method and apparatus for efficiently combining wide-area broadcast transmission ability of satellites with local broadband services is desirable to provide a substantial portion of the bandwidth-on-demand services where long-haul fiber optic links are less available. In addition, solutions to this problem require an inexpensive method and apparatus for providing bandwidth-on-demand services with minimum latency and capability for diverse traffic routing. Any such solution, however, must interoperate with current Internet routing and switching technology and standards, particularly the Internet Protocol, Ethernet, and routing protocols such as Border Gateway Protocol No. 4 (BGP-4). Furthermore, the facility thus offered can facilitate the relationship and exchange of data between Internet Service Providers (ISPs) through the principle of the Internet Exchange and peering, currently only available to Tier 1 ISPs based largely in the US and Western Europe.

A network backbone is the portion of a network that carries transit traffic between separate and distinct local/regional networks. A robust Internet backbone may be defined according to one or more desirable parameters, including the following: a high network capacity, potentially reaching as much as 1 Gbps; high-speed connectivity per node, such as on the order of greater than 30 Mbps; a mesh configuration wherein each node may communicate directly with every other node in the network via one hop over the satellite; and a self-healing fault tolerance such that a malfunctioning node does not hamper the performance of the rest of the network. In addition, it would also be beneficial to have a Network Operation Center (“NOC”) which could manage certain network operations, such as the allocation of bandwidth, introduce new nodes into the network, and arrange for peering agreements between distinct ISPs. Presently, such satellite based systems require multiple operation centers to manage inter-node agreements as well as agreements between distinct ISPs located on the same node.

Satellite transmission that does not account for the nature of the Internet as a collection of loosely-connected subnets will suffer from performance problems that degrade service quality. Since most of the available satellite capacity is from geostationary earth orbit (“GEO”) satellites, there is a quarter of a second delay per hop. In addition, there is no direct control of routing signals. Thus, IP traffic can and will be subject to multiple hops and attendant delay. Additional performance issues can develop at particular access nodes due to a potential for bottlenecking at the terrestrial interface. Integration of satellite and terrestrial networks for IP routing is inherently problematic, unless the satellite network properly addresses such issues as improper window size, delayed acknowledgment of lost packets, poor bandwidth adaptation and asymmetric link capacity. The latter issue may not be a problem today in a developing region, but will greatly hamper service quality as intra-regional demand grows.

Currently, satellites serve a purpose within Internet access markets, but satellites are not being deployed efficiently in a backbone scenario. The main role as it exists prior to VOS is to establish a point-to-point link from a remote ISP over a satellite to a point of access to the global Internet served by high-quality fiber optic cable. Because this link is sold and provided on an individual basis, the transmission scheme rarely employs a standard scheme such as DVB-S. This is unfortunate because DVB-S, now dominant in the digital satellite broadcasting direct-to-home service, offers very efficient transfer of IP data through IP Encapsulation (IPE) and provides a robust modulation, coding and security scheme for satellite transmission. The facility of IPE allows a DVB-S operator to deliver Internet content on a simplex or multicast basis; however, any return channel transmission for interactivity is at a relatively low speed using either a terrestrial dialup line or narrow-band packet satellite transmission. While some of today's DVB-S networks exhibit a high network capacity (i.e., greater than 30 Mbps), current DVB-S networks are deployed in a hub-centric star topology to facilitate broadcasting (the primary revenue generator). This undesirably results in asymmetrical Internet access (e.g., 30 Mbps shared one-way; 16-384 Kbps the other way). Although such asymmetrical Internet access may suffice for corporate access markets or direct-to-home use, it is insufficient for the critical backbone infrastructure required by telecommunication service providers, such as carriers, ISPs, cable operators major corporate or government user, or the like.

Additionally, current hub-centric star topology systems do not encourage growth of the system. Each network hub typically operates independently of other network hubs, thereby encouraging growth of each hub's capacity on a singular level rather than encouraging growth of the entire hub capacity as a group. Moreover, because every hub operates virtually independently of every other hub, there is loss of satellite service for the associated network if the hub becomes inoperable.

An important benefit of using DVB-S to provide the backbone transmission is its tight integration with the Internet Protocol through IP Encapsulation. This is accomplished efficiently and transparently, without the need for protocol conversion or “spoofing”. Some benefit can be gained from IP acceleration and caching, techniques that can be included depending on requirements of end users. Regardless of whether these features are added or not, VOS can transfer IP packets and permit routers to communicate and be managed with standard processes and protocols.

There is a need for a satellite Internet backbone topology that overcomes the aforementioned drawbacks.

### SUMMARY OF THE INVENTION

The present invention relates to an Internet backbone system comprised of a system of one or more satellites that are communicatively coupled to a system of terrestrial nodes. The maximum theoretical network capacity of the present invention is greater than 1 Gbps per GEO satellite. Each terrestrial VOS node is provided with an uplink and downlink communication path to the satellite system through the facility of a ground station referred to as a teleport. The maximum connectivity per node is 100 Mbps uplink and greater than 1 Gbps downlink.

Additionally, each node is communicatively coupled to every node in the system such that the nodes are arranged in a mesh configuration. If one node becomes inoperable, traffic to and from the other nodes is not affected. Traffic to the inoperable node may be re-routed through alternate paths if alternate routing is available via the Internet.

The wireless Internet backbone of the present invention employs a DVB-S “hubonly” architecture, wherein each node in the satellite network acts as a DVB uplink and as a downlink for all other nodes. This allows for the stacking of multiple carriers onto the same network on the same GEO satellite. Consequently, the total network capacity grows as nodes are added to the network. Furthermore, full network bandwidth is available for use by any point in the network because every node is directly and communicatively connected to every other node in the network. This differs greatly from existing high-capacity networks, which do not make the total network bandwidth available to each and every node.

While the present invention employs a DVB-S “hub-only” architecture, one of ordinary skill in the should realize that the present invention is not so limited and other specifications for satellite and cable broadcasting of digital signals are also contemplated by the present invention. For example, the packet structure, modulation and coding format of DVB-S can be replaced on a piece-by-piece basis with other techniques generally available and described in the literature. See Introduction to Satellite Communication, Second Edition, by Bruce Elbert, published by Artech House, Inc., Boston, 1999.

Applicant has developed an efficient routing policy to accommodate and efficiently manage the disclosed multi-homed topology. The fundamental routing of network traffic into and out of VOS is handled through a routing protocol exemplified-by the standard Internet routing protocol, the Border Gateway Protocol (“BGP4”). The BGP4 provides various features related to traffic routing, including load balancing, the determination of best-route paths, and the re-routing of traffic in event of network failure. The BGP4 results in a high efficiency of bandwidth utilization. In addition, there is no single point of failure in the present invention due to multi-homing and BGP4. However, failure may occur if only a single satellite source is used. Preferably, the present invention provides for redundant satellite communication availability so that the network does not fail in the event of a single satellite failure. In this instance, the teleport antennas may be redirected to the backup satellite, or a replacement satellite can be transferred into the orbital location of the failed satellite.

Virtual on-board switching (“VOS”) performs routing and switching to interoperate cohesively with international standards for satellite uplink and downlink equipment and various terrestrial IP networks that employ routing protocols such as BGP4. This approach allows VOS to effectively link between satellite and terrestrial networking infrastructure to allow groups of ISPs to establish and maintain full-mesh connectivity. Thus, this approach results in the implementation of a dynamic Internet backbone that is robust, efficient and scalable to large aggregate bandwidths.

According to the present invention there is provide a communications network and method comprising: a plurality of adapted teleports for communication with at least one assorted communications satellite, such that each of said teleports are in wireless communications with each other therewith; a virtual on-board switching means for switching data signals, said virtual on-board switching means including: a data aggregation means for aggregating data signals transmitted and received from said teleport; a backbone switch means for switching data transmitted and received from said data aggregation means; and an encapsulator means for encapsulating data signals transmitted from said backbone switch means; a client router communicatively linked to said virtual on-board switching means; a client workstation communicatively linked to said client router, said client workstation including an interface means adapted for interfacing a plurality of associated subscribers to said client workstation.

According to another aspect of the present invention there is provided a communications network management system comprising: a communications satellite; a plurality of teleports in wireless communication with said communications satellite, such that each of said teleports are in wireless communications with each other via said communications satellite; a portal which has access to a plurality of client computers in communication with said teleports; and a negotiating means to allow subscribers of said teleports to negotiate peering arrangements.

According to another aspect of the present invention there is provided a communications system comprising: a digital video broadcast satellite system; plural remote access nodes coupled to data sources of the Internet and to the digital video broadcast satellite system, wherein every remote access node is communicatively coupled to every other remote access node such that every remote access node is configured to function as a digital uplink and downlink for every other remote access node.

An advantage of the present invention is a wireless Internet backbone using an intelligent routing and switching scheme designed to link satellite equipment with various terrestrial IP networks.

Another advantage of the system is the mesh network of teleports capable of communication with each other via one satellite hop.

Still another advantage of the present invention is to provide a wireless Internet backbone architecture that is robust and easily scalable.

Another advantage of the present invention is a low latency wireless Internet backbone which provides efficient regional support of world wide web, VoIP, and other Internet based applications.

Still another advantage of the present invention is to allow remote management of the entire wireless Internet backbone located anywhere in the world with access to the global network, including at any one of the teleports and distinct from other teleports.

Another advantage of the present invention is to provide a wireless Internet backbone architecture which has a self-healing fault tolerance such that a malfunctioning teleport or node does not hamper the performance of the remainder of the network.

Another advantage of the present invention is that it allows ISPs and other service providers to achieve and manage relationships amongst themselves through both the facility of the NOC and in an automated manner using a secure web portal.

### BRIEF DESCRIPTION OF THE DRAWINGS

FIG. 1 is a schematic diagram of the satellite system of the present invention.

FIG. 2 is a schematic diagram of the logical network topology of the present invention.

FIG. 3 is a block diagram of the virtual on-board architecture of the present invention.

FIG. 4 is a schematic diagram of the satellite system of the present invention implementing a network operations center.

FIG. 5 is a schematic diagram of the architecture of the present invention.

FIG. 6A is a block diagram of the present invention illustrating an Ethernet link between the ISP and the VOS equipment.

FIG. 6B is a block diagram of the present invention illustrating a microwave link between the ISP and the VOS equipment.

FIG. 6C is a block diagram of the present invention illustrating a point-to-multipoint RF link between the ISP and the individual subscribers.

FIG. 7 is a block diagram illustrating an exemplary data path associated with the present invention.

### DETAILED DESCRIPTION OF THE PREFERRED EMBODIMENT

Throughout this description, the preferred embodiment and examples shown should be considered as exemplars, rather than limitations on the apparatus and methods of the present invention.

At an altitude of approximately 36,000 km above the equator, a GEO satellite period is 24 hours, so the satellite revolves around the Earth in a fixed location above the Earth. For an Earth based observer or teleport (ground station or satellite dish), the satellite has a fixed spot in the sky, which appears motionless to the observer or the teleport. Some motion of the satellite about this fixed spot is normal, due to orbit inclination and other perturbations; ground antenna tracking may be required if this motion would cause the satellite to move outside the beam of the teleport antenna. For the purposes of this application, the terms satellite dish, teleport, ground station and node shall be used interchangeably to denote a terrestrial—satellite interface that contains VOS equipment. The GEO-satellite of the present invention is a wide coverage satellite not intended for direct use by the user. However, on rare occasions, when a user requires extremely high bandwidth, the present invention may be so configured to meet such users demands. This dual role is possible because of the blended use of satellite transmission technology with Internet routing.

The main frequency bands for satellite communications are the C band in the 3.7-4.2 GHz range for downlink and 5.925-6.425 GHz range for uplink, the X band in the 7.25 to 7.75 GHz for downlink and 7.90 to 8.40 GHz for uplink; the Ku band in 11.7-12.2 GHz range for downlink and 14.0-14.5 GHz range for uplink and the Ka band in 17.7-21.7 GHz range for downlink, 27.5-30.5 GHz range for uplink. The fact that the frequency allocations of the International Telecommunication Union (“ITU”) indicate some variation between global regions does not alter the principle of VOS and its use in satellite communications. However, each of these of bands has associated problems. For instance, systems utilizing the Ku and Ka bands perform poorly with inclimate rainy weather and systems utilizing the C-band may experience service degradation when faced with terrestrial interference from ground-based microwave stations on the same frequency (permitted under the ITU frequency allocations in many countries). The present invention is currently directed to the C-band since this band can cover the widest region with minimum outage due to rain. Furthermore, teleports are generally located in areas with reduced terrestrial interference at these frequencies. However, it should be appreciated to one of ordinary skill in the art that the novelty of the present invention is not so limited and other bands, including the X band, Ku band and the Ka band are also appropriate frequency bands in which the present invention may operate.

Referring now the drawings wherein the illustrations are for the purposes of illustrating a preferred embodiment of the invention only and not for purposes of limiting same.

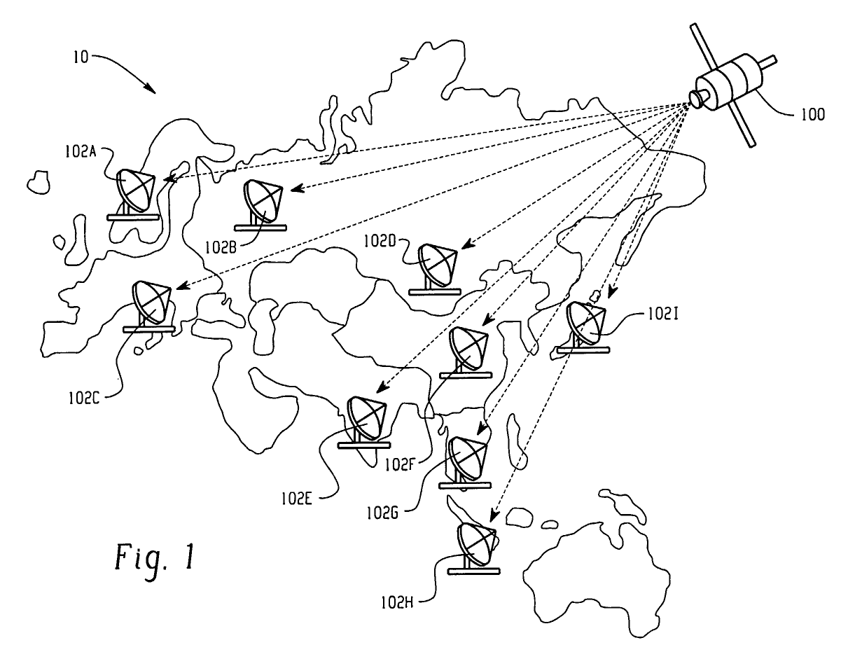

FIG. 1 illustrates a network of teleports used to transmit and receive information via a satellite. A large earth station used at C-band to provide services to multiple users is called a teleport or ground station. Typically, such teleports are connected to multiple ISPs located within the same city or geographical area. Since the teleports provide service to multiple ISPs, the teleports transfer and received data to/from the satellite at much higher data rates than the data rate provided by any single ISP. Typically, the teleport uplink is in the range of 3 to 100 Mbps, although higher data rates are possible by employing multiple DVB-S carrier frequencies. As stated above, the present invention provides for diverse routing from one teleport to another. Thus, there is no single point failure associated with the present system, i.e., loss of one teleport or terrestrial access to it only affects the communication with locally-connected users and not the remainder of the satellite network.

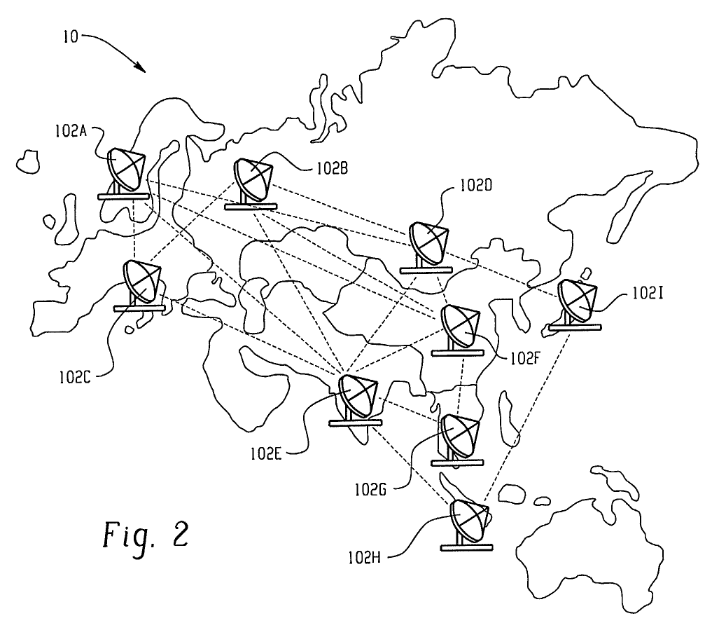

As shown in FIG. 1, a network or system 10 comprises a mesh network of high-bandwidth teleports 102A-102I that are in communication and connected to each other by a satellite 100. The network 10 of high-bandwidth teleports 102 is served by VOS and the satellite 100 which act as an Internet Exchange (described below) and provide an Internet backbone as well. The network 10 depicts a satellite 100, teleports 102A-102I strategically located to serve local ISPs the needed Internet services. Each of the teleports 102 may be linked directly to any other teleport by only one hop. This is explicitly shown in FIG. 2.

As shown in FIG. 2, the teleports 102A-102I are interconnected nodes which form a low latency (one hop) satellite link, e.g., 260 ms from the teleport 102 to the satellite 100 to another teleport 102, and 20 ms or less of processing and switching delay associated with VOS in both teleports, the total delay from any ISP to any other ISP within the satellite footprint is under 300 ms. In addition, the VOS architecture of the present invention does not modify the routing protocols which results in a network 10 may seamlessly carry a variety of services including, but not limited to, Internet (www data and media, e-mail, file transfer, etc.), IP video and audio content, and voiceover-IP (VoIP). In addition, since the network 10 has a low latency (less than 300 ms) including node processing, any teleport 102 can directly originate content to any other teleport as well as broadcast that content to receive-only users throughout the satellite footprint.

The mesh network 10 shown in FIG. 2 makes use of virtual on-board switching (“VOS”). VOS provides a flexible and scalable Internet architecture for the broad range of services and applications that can be offered across a diverse region such as that shown in FIG. 2. Using existing GEO satellite transponder capacity, an existing teleport 102 can be converted into a VOS node in a mesh architecture for routing and managing IP traffic. This conversion is straightforward, whereby the VOS equipment is inserted between the conventional radio frequency (“RF”) electronics (which provide the uplink and downlink transmission paths to the satellite) and the terrestrial interface (discussed below).

The role of VOS is to transfer IP packets from the local ISPs (or the Internet itself) to the appropriate satellite transmission path. In its most direct implementation, VOS involves the integration of Layer 2 switching and Layer 3 routing of the Opens Systems Interconnection (“OSI”) network protocol layers into a bundled platform. Layers 2 and 3 are part of the seven layer OSI stack and are associated with basic packet-switched telecommunications network infrastructure. Above these layers are the protocols and services associated with the computer systems and servers that are typically located with end users. For example, Transmission Control Protocol (TCP) is used at the next immediate layer by desktop computer “clients” and backend “servers” that need a mechanism for reliably transferring data over a network such as that provided by VOS and the Internet in general. TCP is employed further by the World Wide Web in its capacity of making various forms of content available to web surfers throughout the planet.

The VOS system differs from existing technologies and network implementations in that the switching and routing are separated into two distinct functional elements: a connection control component and a packet forwarding algorithm. The basic implementation of VOS is to employ Ethernet switching within the teleport and IP Encapsulation over the satellite as a distributed connection control layer. This is easily possible because the combination of the IPE on the uplink side and the IRD on the downlink side allows individual connectivities to be defined and implemented quickly and reliably. The routing function of VOS is carried out totally within the framework of a standard routing protocol like BGP 4, which automatically transmits network configuration, status and updates when and where needed. The previously described IPE switching scheme is transparent to BGP 4, allowing routers operated by the ISPs to do their job naturally and un-impeded.

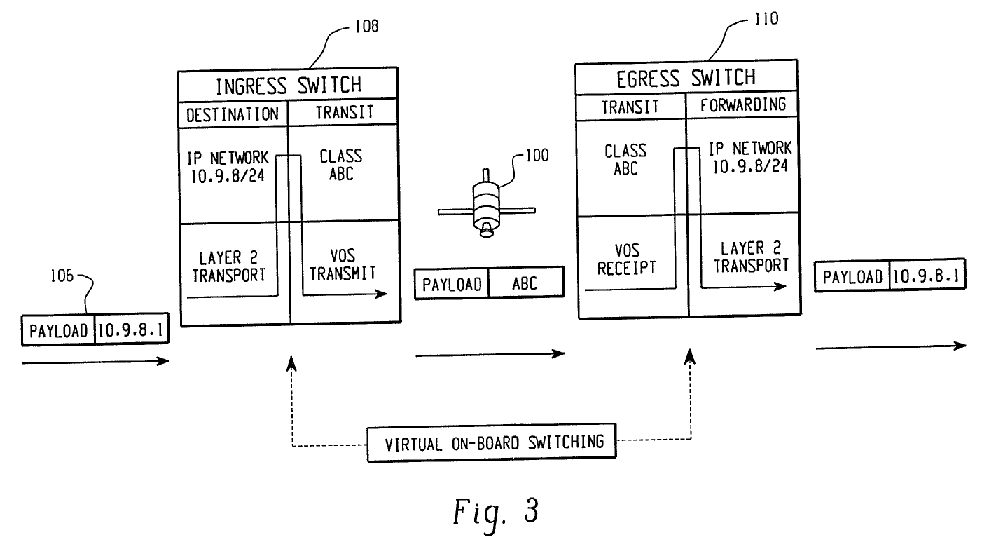

FIG. 3 shows the basic components of VOS. As shown, a packet 106 is routed to an ingress switch 108 and transmitted to the satellite 100. The satellite 100 acts as a bent pipe and merely broadcasts the received signal without any modifications; RF equipment of the receiving teleport routes the signal to the egress switch 110 of the selected receiver. The output of the receiver 112 consists of the original transmitted data packet 106. Thus, the transfer between teleports from ingress switch 108 and egress switch 110 is fast and transparent to the IP packet. The network is then made up of all possible paths amongst teleports, using this routing/switching scheme provided by VOS. The switching is fast and reliable, providing paths that can be implemented through software and central management.

The importance with this approach lies in the complexity of mapping between two distinct architectures (e.g., satellite communications and the terrestrial Internet) that require the definition and maintenance of separate topologies, multiple access, address space, routing protocol, signaling protocols, and bandwidth allocation schemes. However, once these issues have been resolved, as is the case with VOS, the result is a flexible and robust networking platform that overcomes many of the shortcomings associated with current satellite and terrestrial cable implementations. In the past, these shortcomings impeded use of satellite networks within the Internet backbone except as an access scheme. Even in the age of fiber optic technology, land and sea cable links do not offer a consistent infrastructure for developing regions of the world.

The mesh network 10 and service delivery system of the present invention are managed by a regional network operating center (“NOC”), located at a VOS node or externally to the network 10. In addition, at least one teleport 102 offers direct fiber connectivity to the global Internet; a second such teleport-fiber combination provides diverse routing in case of congestion or failure at the first teleport 102 The versatility of IP as a basic data transfer mechanism, IP Encapsulation within a DVB-S and/or MPEG-2, in conjunction with both open and proprietary routing and management technology, achieve bandwidth-on-demand capability over a satellite network that requires little physical modification and control. Standard monitor and control systems within the teleports, in conjunction with the satellite operator's transponder monitoring scheme, are all that are necessary to assure basic link performance. All of the routing and traffic engineering are conducted through the network management that is provided out of the NOC. In addition, by taking advantage of the characteristics of IP, the NOC or other nodes if desired, may manage bandwidth by scaling bandwidth on uplinks and downlinks from any site.

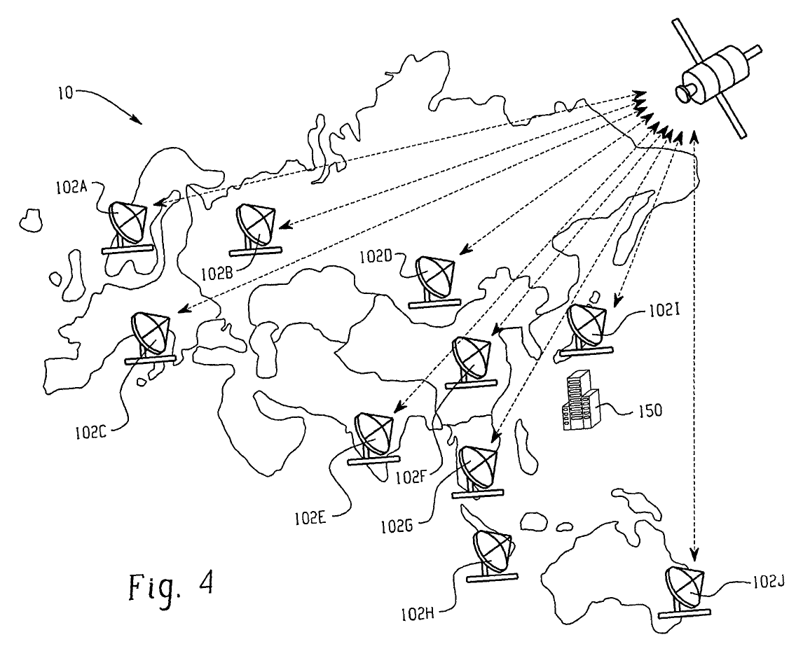

As described in FIG. 4, VOS nodes are located in local teleports 102 and are interconnected by a common satellite through a mesh architecture. A single NOC 150 manages the entire infrastructure and assures that high quality IP services are delivered on a continuous and optimum manner. Of course, a second NOC can be added for redundancy; it may even be located outside the footprint by using the Internet, itself, to extend control to the VOS network 10. This is made possible by using the Simple Network Management Protocol (SNMP), which is provided as an application layer protocol within the Internet framework.

In FIG. 4, the node 102I has a direct terrestrial link to the teleport 102I. Thus, the node 102I and at least one other VOS node 102 provide direct connections via fiber to the global network. The VOS node 102 is the local point-of-presence for all services, allowing one or more ISPs to employ satellite bandwidth and obtain connectivity with ISPs connected to other VOS nodes as well as the full global reach of the Internet itself. The VOS equipment is configured for the specific capacity requirements of each location and integrated with the RF terminal and terrestrial interface.

Another aspect of VOS is its ability to take any type of user traffic and map it to a path that has been designed to satisfy user specific requirements. Termed Quality-of-Service (“QoS”), this allows ISPs to create an array of satellite network topologies and services designed to traffic requirements such as minimum end-to-end delay or guaranteed delivery. Unlike the complex and expensive broadband satellite systems using digital on-board processing to allow mesh connectivity, the present invention may use bent-pipe GEO satellites that have been in use since the 1970s. This is not to say that VOS cannot be applied to processing satellites as well, only that it can be introduced over bent-pipe satellites without loss of full mesh connectivity. VOS employs proven and reliable ground-based equipment the majority of which is sold on the international market to form a dynamic IP switching fabric that is extended to teleport nodes 102 and connected to ISPs. Within the teleport 102, specialized VOS baseband equipment implements and manages network services.

As previously stated, VOS effectively links between satellite 100 and terrestrial Internet networking infrastructure to allow service providers and major corporate and governmental users to establish and maintain full-mesh broadband connectivity. The present invention allows service providers to construct customized VOS routes that support specific application requirements using QoS features. These routes can be selected to meet certain bandwidth requirements, support precise performance requirements, or simply force traffic across certain links to specific nodes in the network.

FIG. 4, also illustrates the ease in adding an additional teleport. For instance, teleport 102J is added to the network by simply building a teleport (if one is not already in place), installing the VOS baseband equipment, and updating the network's associated ARP table (a function of the NOC) and sending basic subscriber information to the NOC 150. Once in place, the normal function of a routing protocol, such as BGP4, is to inform other routers in the network of the existence and capability of the new node.

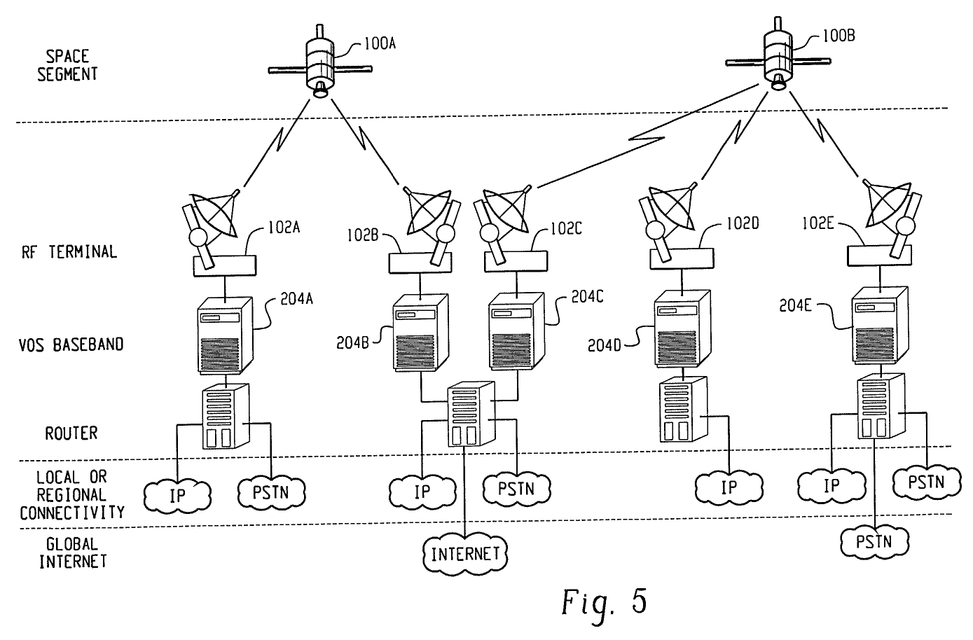

FIG. 5 illustrates the basic architecture of the present invention. As shown, the architecture consists of at least one satellite 100. An RF component comprising at least two teleports 102 which can communicate with the satellite 100. A VOS baseband component comprising VOS equipment 204. A router component comprising a router 202 capable of managing IP packets. A connectivity component comprising local or regional connectivity to IP and/or public switched telephone network (“PSTN”). A global Internet component which takes the form of a terrestrial link to either the Internet or PSTN. As shown in FIG. 5, the network architecture comprises placement of specialized VOS baseband equipment between the router (provided by or for the ISPs receiving service) and the teleport radio frequency equipment.

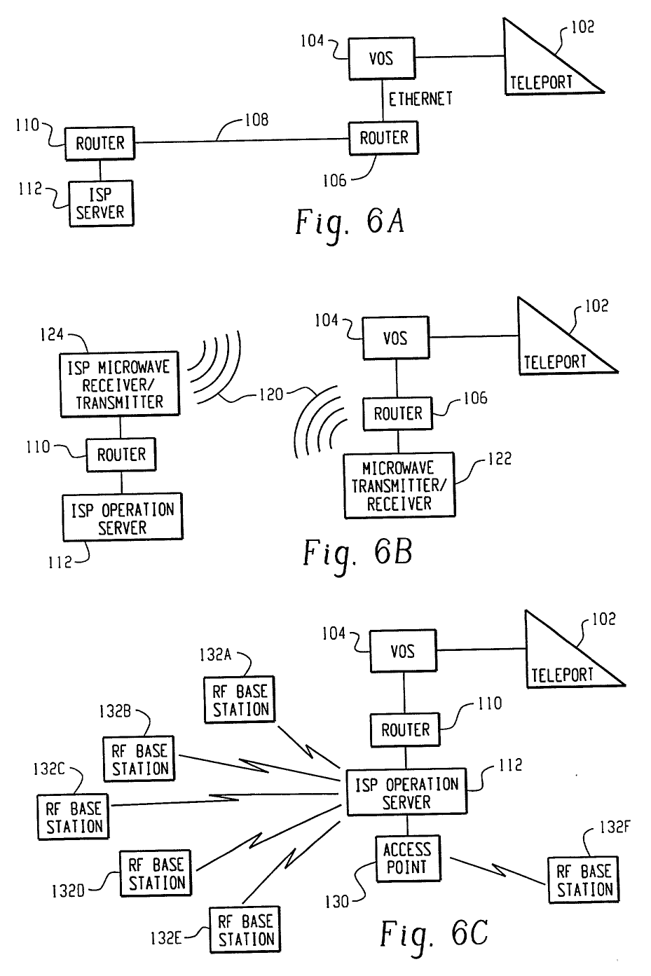

The present invention supports at least three interfaces from the ISP or major user to the VOS nodes 102. As shown in FIG. 6A, the teleport 102 is connected to the VOS equipment 104 which, in turn, is linked to the co-located router 106 of the ISP via 10 or 100 Base-T Ethernet. A terrestrial link or leased line 108 is connected to a router 110 which is connected to the ISP operation server 112. The terrestrial line 108 may take many forms, including but not limited to ADSL, SDSL, T1, E1, T3, E3, OC and SDH, etc.

In FIG. 6B, the teleport 102 is connected to the VOS equipment 104 which, in turn, is linked to the co-located router 106 of the ISP. The router 106 is linked via a microwave link 120 provided by a standard teleport 102 as described above. The microwave transmitter/receiver 122 transmits and receives microwave signals from the ISP microwave receiver/transmitter 124. The ISP microwave receiver/transmitter 124, in turn, is interfaced to the ISP router 110 and the ISP operation server 112.

In FIG. 6C, the teleport 102 is similarly connected to the VOS 104 and a co-located router 110 to the ISP server 112. The ISP server 112 is interfaced to a fixed wireless (point to multipoint access point) 130. Individual subscribers utilize standard RF base stations 132A-132F to connect to the access point 130. It should be appreciated that this embodiment of the present invention is described and utilizes terms used in the IEEE 802.11 Standard, the respective terminology is not intended to limit the scope of the present invention. In this regard, the present invention is suitably applicable to a wide variety of other communication systems which utilize a plurality of operating frequencies as well as various mediums for data transmission through a facility of fixed wireless or wireless local loop. In this manner, the ISP (or other operator) may employ the teleport at its principal place of business and serve its subscribers or users directly without the need for terrestrial links.

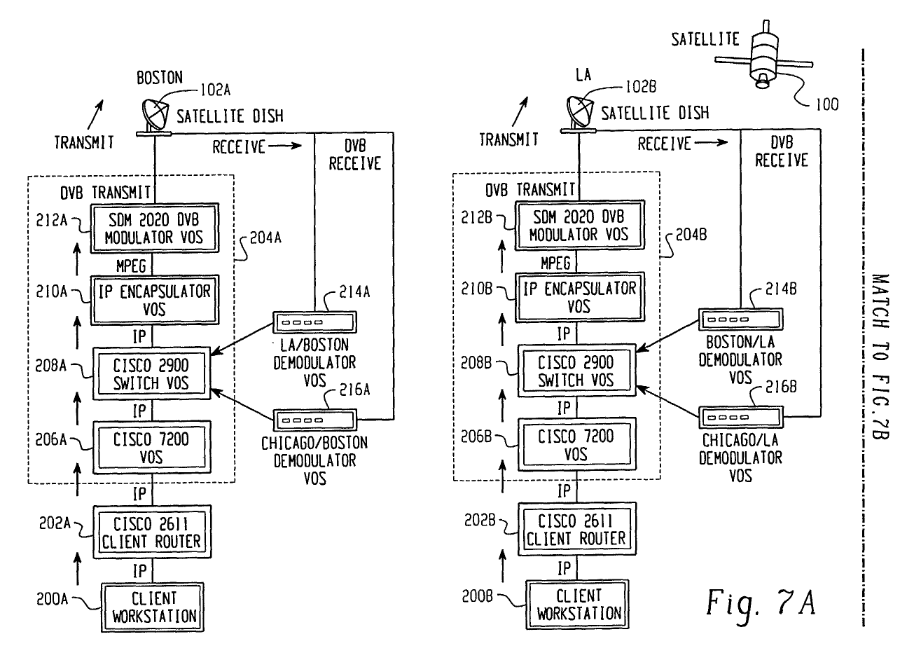

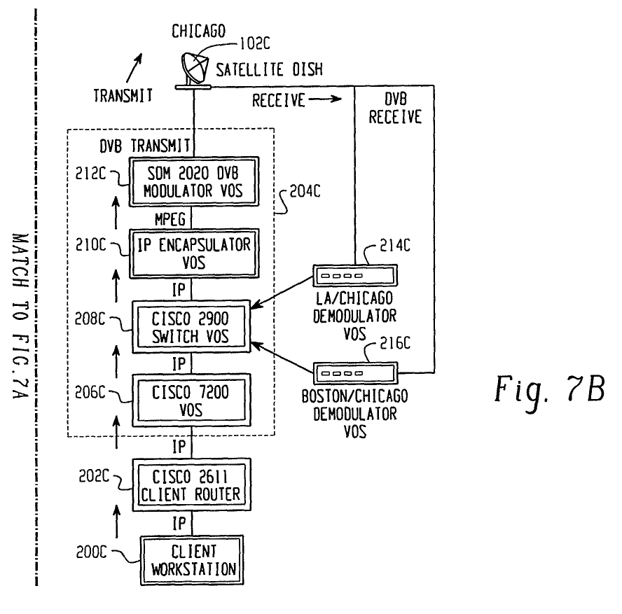

FIG. 7 illustrates an exemplar embodiment of the present invention. A typical workstation 200 for the present invention includes: a client router 202 and VOS equipment. As shown the client router 202 is a Cisco 2611 router manufactured by Cisco Systems, Inc. of San Jose, Calif. The VOS equipment comprises a Cisco 7200 broadband access services aggregator 206, a Cisco 2900 backbone switch 208, an IP encapsulator (“IPE”) 210, and a SDM-2020 DVB modulator (or satellite modem) 212 manufactured by California Microwave, Inc. of Sunnyvale, Calif.

In general operation, IP packets are generated by the client workstation 200. The IP packets are then input to the broadband access services aggregator 206 and output to the backbone switch 208. The IP packet is then routed to the IPE 210 and transferred to an MPEG stream. The MPEG stream is routed to the DVB modulator and then to the teleport 102 for transmission.

On the receive side, FIG. 7 illustrates DVB data being received the by teleport 102, routed to an associated integrated receiver decoder (“IRD”) 214 to transfer the MPEG stream to IP packet form. The packet is then routed to the backbone switch 208, the aggregator 206, the router 202 and then to the client workstation 200.

As shown in FIG. 7, the path of data from the client side workstations up to the VOS equipment and back down to another site's client workstation. The steps in this process are: Boston's client workstation 200A makes a request for IP data from LA's client workstation 200B. Boston's workstation 200A uses a router 202A to connect with the VOS equipment 204. The router 200A determines the route needed to reach the LA client workstation using the routing protocol “BGP”. Once the path is determined the IP data is passed onto the IPE 210, the VOS equipment applies the appropriate tag to assign the packet to the correct downlink. This device encapsulates the IP data into an MPEG stream of the DVB-S standard. The IPE 210 is connected to a DVB-S modulator, which in turn takes the MPEG stream and converts it into a DVB-S format, which can be transmitted via satellite 100.

Both LA and Chicago's site will receive the data, but only in the LA site will the demodulator 214B accept the data (based on MAC addressing from the Boston router's ARP table). Once the DVB and MPEG stream is demodulated the IP data is sent to the router 206B that is part of the VOS equipment. The VOS router then passes the IP data down onto the client's router 202B, which in turns passes to the client workstation 200B.

Because the invention makes use of the standard Internet protocol, BGP4, the system will automatically find the best path from end point to end point. Like, terrestrial based systems, such routing decisions are made at the router 202 linked to the attached VOS equipment 204.

The disclosed satellite Internet backbone system employs a DVB-S “hub-only” architecture, wherein each node in the satellite network acts as a DVB uplink and as a downlink for all (or some of the) other nodes. This allows for the stacking of multiple carriers onto the same satellite, thereby dramatically increasing the total capacity and connectivity of the network. A VOS teleport is equipped with sufficient DVB-S integrated receiver-decoders (IRDs) to receive the carriers transmitted by its associated teleports in the network. Consequently, the total network capacity grows as nodes are added to the network. Furthermore, full network bandwidth is available for use by any point in the network because every node may be directly and communicatively connected to every other node in the network. This differs greatly from some existing high-capacity satellite networks, which do not make bandwidth available to each and every node. (An exception is time division multiple access, used for telephone trunking and teleconferencing networks, which requires tight control of transmission timing from earth stations that transmit at the same high data rate.)

The present invention makes use of the Border Gateway Protocol (“BGP”). An autonomous system number (“ASN”) is a unique number assigned by the InterNIC that identifies an autonomous system in the Internet. ASNs are used by routing protocols (like BGP) to uniquely define an autonomous system. An autonomous system is a collection of routers under a single administrative authority using a common protocol for routing packets.

BGP is an open protocol, which incorporates an identification scheme not directly related to IP addresses. This permits active management by the network operating center discussed infra. In summary, the present invention utilizes a routing protocol exemplified by BGP to exchange routing information between distinct ISPs.

Multiple ISPs located within close geographical proximity of each other will typically use a single teleport 102 to link to a satellite 100. The present invention provides for peering agreements between distinct ISPs located at the same node or located at a remote node on a completely confidential basis. As defined by Newton's Telecom Dictionary, 16^{th} Edition, by Harry Newton, Telecom Books, 2000, Peering is a relationship established between two or more ISPs for the purpose of exchanging traffic directly, rather than doing so through a backbone Internet provider. The traditional Internet architecture calls for ISPs and regional carriers to exchange traffic at Network Access Points (NAPs), carrier-class switches and routers. Traditionally, that traffic was exchanged at no cost, although that no longer is necessarily true. In order to avoid those costs, therefore, many of the larger ISPs have developed peering relationships which allow them to exchange traffic directly over dedicated circuits. In some geographical regions, mostly in North America, numbers of ISPs have formed “private peering points.” These packet switching centers allow them to exchange traffic on a switched basis, once again avoiding the cost of doing so through a NAP. It is an important ability of VOS to behave as a single integrated packet switching center for peering, and extend that functionality to widely disperse ISPs.

The present invention also enables ISPs to negotiate and enter into peering agreements. Such relationships may be established in two manners. First, ISPs may directly contract with other ISPs through the NOC 150. As previously stated, the present invention allows for a centralized network management center connected to one network teleport 102 or external to the network 10 via the Internet. The second manner in which a peering agreement may be established is automated by the use of a secure web site. In this method, an ISP seeking to enter into a peering agreement with another ISP accesses a secure web site. The secured web site contains a listing of the ISPs associated with the teleports 102 of the network 10. In some cases, an ISP may have a set agreement price for entering into a peering agreement. In this case, another ISP simply agrees to pay the requested fee to the ISP by completing the appropriate information on the secured web site. In other cases, the secured web site provides a medium for ISPs to negotiate through a portal. The entire negotiation process may take place through the portal in a completely confidential manner. The portal is linked to the NOC 150 either directly or indirectly and interfaces with the management database of the NOC 150. Therefore, once the ISPs have negotiated a peering agreement, the web site will automatically cause the required connectivity to be activated through VOS.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

Having thus described the invention, it is now claimed:

1. A communications network comprising:
a plurality of adapted teleports for communication with at least one assorted communications satellite, such that each of said teleports are in wireless communications with each other therewith;
a virtual on-board switching means for switching data signals, said virtual on-board switching means including:
a data aggregation means for aggregating data signals transmitted and received from said teleport;
a backbone switch means for switching data transmitted and received from said data aggregation means; and
an encapsulator means for encapsulating data signals transmitted from said backbone switch means;
a client router communicatively linked to said virtual on-board switching means;
a client workstation communicatively linked to said client router, said client workstation including an interface means adapted for interfacing a plurality of associated subscribers to said client workstation.

2. The communications network as described in claim 1 wherein each of said plurality of said teleports is in communication with each other teleport via one hop from said communications satellite.

3. The communications network as described in claim 1 wherein said communications network defines latency to be less than 400 ms between said teleports.

4. The communications network as described in claim 1 wherein said interface means comprises a terrestrial link between said subscriber and said client workstation;

5. The communications network as described in claim 1 wherein said interface means comprises a microwave link between said subscriber and said client workstation;

6. The communications network as described in claim 1 wherein said interface means comprises a radio frequency link between said subscriber and said client workstation;

7. The communications network as described in claim 1 wherein said network including means for providing efficient regional support of Internet related services comprising: world wide web data and media, e-mail, file transfer, IP video and audio content, and voice-over-IP applications.

8. The communications network as described in claim 1 wherein said network including means for providing remote management of at least a portion of said network via a remote operations portal connected to one of said plurality of teleports.

9. The communications network as described in claim 1 wherein said network including means for providing remote management of at least a portion of said network via the Internet.

10. The communications network as described in claim 1 wherein said network including means for remote management of bandwidth allocation at each teleport.

11. A method of communications comprising:
a means for adapting teleports for communication with at least one assorted communications satellite, such that each of said teleports are in wireless communications with each other therewith;
a virtual on-board switching means for switching data signals, said virtual on-board switching means including:
a data aggregation means for aggregating data signals transmitted and received from said teleport;
a backbone switch means for switching data transmitted and received from said data aggregation means; and
an encapsulator means for encapsulating data signals transmitted from said backbone switch means;
a means for routing communicatively linked to said virtual on-board switching means;
a communication means adapted for communication between a client workstation and said client router means, said communication means including an interface means adapted for interfacing a plurality of associated subscribers to said client workstation.

12. The method of communication as described in claim 11 wherein said communication means between said teleports and the each other teleport via one hop from said communications satellite.

13. The method of communication as described in claim 11 wherein said interface means comprises a terrestrial link between said subscriber and said client workstation;

14. The method communication as described in claim 11 wherein said interface means comprises a microwave link between said subscriber and said client workstation;

15. The method of communication as described in claim 11 wherein said interface means comprises a radio frequency link between said subscriber and said client workstation;

16. The method of communications as described in claim 11 wherein said method including means for providing remote management of at least a portion of said network via a remote operations portal connected to one of said plurality of teleports.

17. The method of communications as described in claim 11 wherein said method including means for providing remote management of at least a portion of said network via the Internet.

18. The communications network as described in claim 11 wherein said method including means for remote management of bandwidth allocation at each teleport.

19. A communications network management system comprising:
a communications satellite;
a plurality of teleports in wireless communication with said communications satellite, such that each of said teleports are in wireless communications with each other via said communications satellite;
a portal which has access to a plurality of client computers in communication with said teleports;
a negotiating means to allow subscribers of said teleports to negotiate peering arrangements.

20. A communications system comprising:
a digital video broadcast satellite system;
plural remote access nodes coupled to data sources of the Internet and to the digital video broadcast satellite system, wherein every remote access node is communicatively coupled to every other remote access node such that every remote access node is configured to function as a digital uplink and downlink for every other remote access node.
